(19) United States
(12) Patent Application Publication
(10) Pub. No.: US 2020/0192296 A1
(43) Pub. Date: Jun. 18, 2020

(54) WATCH FRAME AND WATCH

(71) Applicant: Karan Sharma, New Delhi (IN)

(72) Inventor: Karan Sharma, New Delhi (IN)

(21) Appl. No.: 16/237,152

(22) Filed: Dec. 31, 2018

(30) Foreign Application Priority Data
Dec. 13, 2018 (CN) 201822092825.7

(51) Int. Cl. G04B 37/00; G04B 19/06; A44C 5/18

(52) U.S. Cl. CPC G04B 37/0008; A44C 5/18; G04B 19/06

(57) ABSTRACT

The present utility model discloses a watch frame, which is provided with a groove for mounting a dial, and the inner wall of the groove is provided with an elastic clip strip for elastically clamping the dial. The beneficial affected areas are below: An elastic clip strip is set in the groove of the watch frame, due to flexibility of the elastic clip strip it is compressed when the dial is installed so that the dial can be easily mounted into the watch frame. The dial can be clamped in the watch frame firmly. When disassembling, the dial can be removed from the watch frame by pressing the dial in downwards motion which saves time and labor and does not need any auxiliary tools.

### BACKGROUND OF THE INVENTION

The utility model relates to the technical field of electronic smart watches and traditional mechanical watches. The utility model specifically relates to a watch frame and a watch.

Watches are common items in people's daily lives. The existing watches generally include smart watches, mechanical watches, electronic watches, sports watches, diving watches, etc. In different occasions, people wear different styles. Usually, watches worn in different occasions are only different from the design of the strap and the watch frame. The design of the dial can be suitable for most occasions. If a suitable watch is needed for every occasion, it will be an economic burden for consumers and a waste of resources for the sustainable development of society. The proposed application of replaceable watch frame or strap lets the user have the ability to change not only the strap but also the watch frame as one unit in terms of aesthetic, material, structural and mechanical design thereby completely changing its appearance.

### SUMMARY

In order to overcome the shortcomings of the existing technology, the first purpose of the utility model is to provide a watch frame and watch, which can be easily disassembled and installed. The purpose of the utility model is realized by the following technical proposal:

A watch frame is provided, which is provided with a groove for installing a dial, and an elastic clip strip for elastically clamping the dial, the elastic clip strip protrudes from inner wall of the groove. Optimally, the elastic clip strip is enclosed to form a clamping hole for interference fit with the dial to clamp the dial. Optimally, the elastic clip strip is a ring structure arranged around the inner wall of the groove; or, the elastic clip strip includes several block structures distributed along the inner wall of the groove. Optimally, the elastic clip strip is an elastic pad.

Optimally, the elastic clamp is fixed on the inner and lateral walls of the groove by bonding. Optimally, the watch frame comprises a ring frame and a baffle arranged at one end of the ring frame and enclosed with the ring frame to form the groove, the elastic clip strip is arranged on the inner wall of the ring frame and the baffle is provided with a window for allowing the user to view the dial through the watch frame. The first purpose of the utility model is to provide a watch, including the watch frame and the dial mounted in the watch frame. Optimally, the elastic clip strip is enclosed to form a clamping hole for the interference fit of the dial to clamp the dial. The interference between the dial and the clamping hole is 0.15-0.2 mm; and/or, the outer surface of the dial is a matte surface.

Optimally, the side portion of the dial is provided with first button and a second button on the side portion of the watch frame corresponding to the position of the first button is provided. A perforated hole on the side of the elastic clip strip is provided corresponding to the position of the first button. The second button has a thimble that can pass through that hole when the second button is pressed and in turn presses the first button to control the action of the first button.

Optimally, the watch also includes a watch band, which is fixed or detachable connected with the watch frame. Compared with the existing technology, the beneficial effects of the utility model is that the elastic clip strip is arranged in the groove of the watch frame, because the clip strip or clamp is elastic, when the dial is installed, the elastic clip strip is elastically compressed, and the dial can be easily loaded into the watch frame, and after the dial is installed in place, under the action of elastic force of elastic clip strip, the dial can be clamped well in the watch frame to ensure the tightness of the dial and the dial installation. When disassembling, the dial can be removed from the watch frame by pressing the dial in downwards motion, saving time and labor, and no auxiliary tools are needed.

### BRIEF DESCRIPTION OF THE DRAWINGS

FIG. 1 is a schematic diagram of the structure of this utility watch model, in accordance with one embodiment of the present invention.

FIG. 2 is a schematic diagram of the watch frame, elastic clip strip and strap of this utility model, in accordance with one embodiment of the present invention.

FIG. 3 is a schematic diagram of the disassembled structure of the watch frame, elastic clip strip and strap of this utility model, in accordance with one embodiment of the present invention.

FIG. 4 is a schematic diagram of the structure of dial of this utility model dial, in accordance with one embodiment of the present invention.

### DETAILED DESCRIPTION OF THE INVENTION

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. It is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements or use of a “negative” limitation.

Next, the present utility model is further described in connection with the drawings and the mode of carrying out the utility model. It is to be noted that, on the basis of without conflict, new embodiments can be formed by arbitrary combination of the embodiments described below or between the technical features.

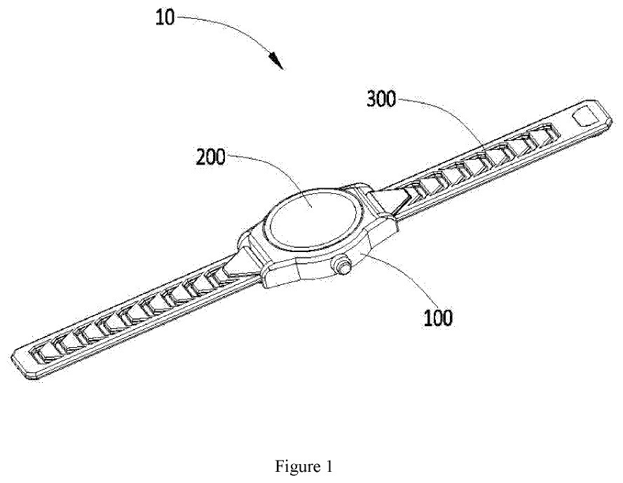

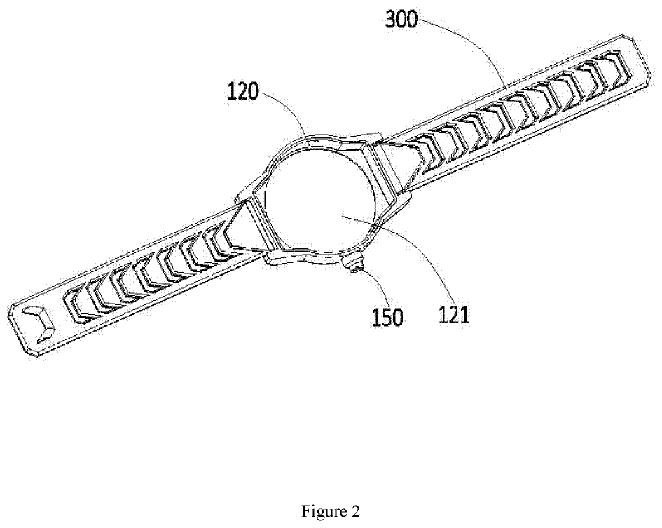

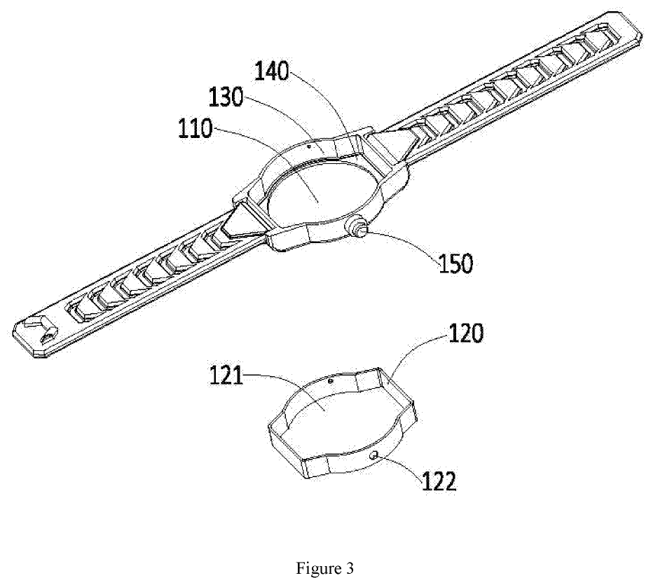

As shown in FIG. 1, FIG. 2 and FIG. 3, a watch frame 100 is provided with a groove (e.g. compartment or space) 110 for mounting the dial 200, and an elastic clip strip 120 for elastically clamping the dial 200 is convex on the inner and lateral walls of the groove 110. Because of the elasticity of the elastic clip strip 120, when the dial is installed 200, the elastic clip strip 120 is compressed, so that the dial 200 can be easily loaded into the watch frame 100, and the elastic clip strip 120 can clamp the dial 200 well within the watch frame 100 to ensure the tightness of the installation of the watch frame 100 and the dial 200; to dismantle the dial, press the dial 200 from top side of dial screen. The dial 200 can be removed from the watch frame 100, saving time and save labor, and no auxiliary tools are needed.

Optimally, the elastic clamp 120 is enclosed to form a clamping hole 121 for interference fit with the dial 200 to clamp the dial 200. The dial 200 is mounted in the clamping hole 121 and clamped by the elastic clip strip 120.

Optimally, Elastic clip strip 120 is a circular structure surrounded by the inner wall of groove 110, or, elastic clip strip 120 includes several block structures distributed along the inner wall of groove 110. In this embodiment, the elastic clip strip 120 is set as a ring structure.

Optimally, the elastic clip strip 120 is a silicone pad. The silicone pad meets the needs of easy disassembly and reinstallation of the dial 200. At the same time, the silicone pad material is soft and won't scratch the surface of the dial 200.

Optimally, the elastic clip strip 120 is fixed to the inner and lateral walls of the groove 110 by bonding. Surely, the elastic clip strip 120 can also use other installation methods, but the bonding method is more convenient and faster.

Optimally, the watch frame 100 includes a ring frame 130 and a baffle 140 arranged at one end of the ring frame 130 and enclosed with the ring frame 130 to form a groove 110. The elastic clip strip 120 is arranged on the inner side wall of the ring frame 130, and the baffle 140 is perforated with a window for users to watch the dial 200. The ring frame 130 forms the side wall of the groove 110, and the baffle 140 forms the bottom wall of the groove 110. When the dial 200 is loaded into the groove 110, the baffle 140 axially locates the dial 200.

A watch 10 is provided, including a watch frame 100 and a dial 200 mounted within the watch frame 100.

Optimally, the elastic clip strip 120 is enclosed to form a clamping hole 121 for the interference fit with the dial 200 to clamp the dial 200, and the interference between the dial 200 and the clamping hole 121 is 0.15-0.2 mm. The interference in this range not only ensures that the dial 200 can be smoothly loaded into the dial frame 100, but also ensure that the dial 200 and the watch frame 100 are clamped and fixed well, so as not to slip.

Optimally, the outer surface of the dial 200 is set as a matte surface, which is a plane with friction. The setting of matte surface can increase the friction between the dial 200 and the elastic clamp 120, which makes the installation of the dial 200 and the watch frame 100 stronger.

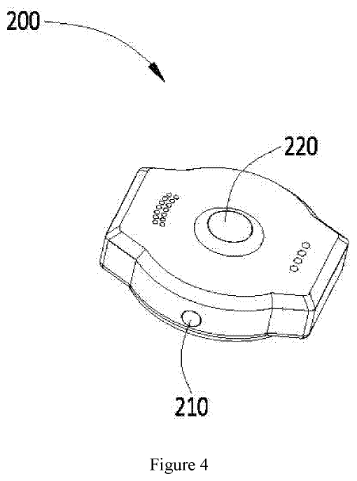

As shown in FIG. 1, FIG. 3 and FIG. 4, the side of dial 200 is provided with a first button 210, the side of watch frame 100 with a second button 150 set in alignment with the first button 210, the side of elastic clip strip 120 with a through hole 122 set in alignment with the first button 210, and the second button 150 which consists with a thimble which can pass through hole 122 to control the pressing action of first button 210. In this embodiment, the electronic watch is selected. After pressing the second button and lasting for two seconds, the watch 10 is turned on; next if pressed once, the watch returns to the previous menu; after pressing the second button and lasting for two seconds again, the watch 10 is turned off; after pressing the second button and lasting for ten seconds, the watch 10 restarts.

Optimally, the watch 10 also includes a strap 300, which is fixed or detachable to the frame 100. In this embodiment, the strap 300 and the watch frame 100 are detachably connected through the connecting shaft.

Optimally, the dial 200 also includes a sensor for detecting the heart rate, which is mounted within the dial 200. On the bottom side the dial 200 near the user's skin, there is a truncated cone 220 for providing a gap between the dial 200 and the user's skin. The position of the truncated cone 220 corresponds to the position setting of the sensor. The gap provided by the truncated cone 220 can bring comfort to users. For example, when sweating, there is a gap between watch 10 and user's skin, hence the dial 200 will not fully stick to the skin. Moreover, the contact between the truncated cone 220 and the user's skin facilitates the detection of human heart rate by the sensor. Furthermore, the gap provided by the truncated cone 220 allows the speaker sound to not be blocked or obstructed fully.

Optimally, the dial 200 includes a loudspeaker module, a microphone module and a charging module. The dial 200 is equipped with through holes connecting the loudspeaker module and the microphone module to facilitate the input and output of sound.

Optimally, the technical proposal of the utility model is applicable to traditional watches electronic watches and smart watches. The style of the watch frame 100 or dial 200 can be diversified. The user can choose to replace the watch frame 100, dial 200 or with its fixed band strap 300 according to the needs of different occasions or trends to satisfy different visual appreciation, save time, effort and trouble.

The above-mentioned embodiments are merely the preferred embodiments of the utility model and not intended to limit the scope of protection of the utility model. Any insubstantial changes and substitutions made by the technical personnel in the field on the basis of the utility model belong to the scope of the protection required by the utility model.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention.

What is claimed is:

1. A Watch frame comprising:
a watch frame having a groove, wherein the groove has an integrated elastic clip strip and lateral walls of the groove are convex; and
a dial, wherein the dial is sized to fit within the groove.

2. The watch frame, of claim 1, wherein the elastic clip strip secures the dial within the groove.

3. The watch frame of claim 1, wherein the elastic clip strip is a ring structure arranged around an inner wall of the groove.

4. The watch frame of claim 1, wherein, the elastic clip strip is an elastic rubber pad.

5. The watch frame of claim 1, wherein the elastic clip strip is fixed to the inner and lateral walls of the groove by bonding.

6. The watch frame of claim 1, wherein the watch frame comprises a ring frame and a baffle arranged at one end of the ring frame and enclosed with the ring frame to form the groove, the elastic clip strip is arranged on the inner wall of the ring frame and the baffle is provided with a window for allowing the user to view the dial through the watch frame.

7. The watch frame of claim 1, wherein the interference between the dial and a clamping hole is 0.15-0.2 mm.

8. The watch frame of claim 1, wherein an outer surface of the dial is a matte surface.

9. The watch frame of claim 1, wherein the side portion of the dial is provided with first button and a second button on the side portion of the watch frame corresponding to the position of the first button is provided. A perforated hole on the side of the elastic clip strip is provided corresponding to the position of the first button. The second button has a thimble that can pass through that hole when the second button is pressed and in turn presses the first button to control the action of the first button.

10. The watch frame of claim 1, further comprising a watch band which is fixed or detachable connected with the watch frame.

11. The watch frame of claim 1, wherein the elastic clip strip is distributed along the inner wall of the groove.
